(19) United States
(12) Patent Application Publication
(10) Pub. No.: US 2017/0110900 A1
(43) Pub. Date: Apr. 20, 2017

(54) BATTERY MANAGEMENT SYSTEM AND METHOD AND BATTERY POWERED APPLIANCE INCORPORATING THE SAME

(71) Applicant: Bookleaf Pty Ltd, Osborne Park (AU)

(72) Inventors: Walter John Edwards, Floreat (AU); Michael Barrington Wood, Mount Lawley (AU)

(73) Assignee: Bookleaf Pty Ltd, Osborne Park (AU)

(21) Appl. No.: 15/300,555

(22) PCT Filed: Apr. 2, 2015
(86) PCT No.: PCT/AU2015/050152

§ 371 Date: Sep. 29, 2016

(30) Foreign Application Priority Data
Apr. 2, 2014 (AU) 2014901200

(51) Int. Cl. H02J 7/00; A01G 25/16; A01G 27/00; A01G 25/02

(52) U.S. Cl. CPC H02J 7/0081; H02J 7/0068; A01G 25/02; A01G 25/165; A01G 27/003; H02J 7/345

(57) ABSTRACT

A controller (11) in a tap timer, having a battery (19) for connected via a charge circuit (23) to selectively charge a storage capacitor C2. The storage capacitor C2 is connected to an actuator circuit (25) to selectively provide power from the storage capacitor C2 to actuate a device M1. A processor (13) controls the actuator circuit (25) according to a pre-programmed schedule or on user demand. The processor monitors various parameters including charge rate of the capacitor C2 in order to determine battery condition, to determine if the processor (13) should next actuate the device (13).

### TECHNICAL FIELD

This invention relates to power supplies for electronic and electrical appliances, and in particular a system and method of managing operation of a battery powered appliance.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

There are some applications for electrical and electronic appliances where battery power from batteries is utilised, usually where deriving a power supply from mains electricity or other relatively inexhaustible supply is inconvenient or impossible. Typically the batteries are self contained with the appliance. The batteries may be primary cells or can be secondary cells (rechargeable) associated with a small solar cell, also co-located with the appliance.

An example of an appliance of the type discussed above is a tap timer (or faucet timer) for controlling water flow to garden sprinklers or drippers for irrigating a garden bed or pot plants. Such a tap timer is fitted to a garden tap, the garden tap then being left with its hand operated valve in the open position. The tap timer can be programmed with a timetable to open and close an internal electrically operated valve within the tap timer, in order to supply water for a predetermined time, at predetermined times or intervals, to achieve the garden watering. The typical intervals may be once a day on predetermined days as may be dictated by regulatory authorities, once every second day, once a day, or several times per day, commencing at predetermined times, as programmed by the user.

A problem with these tap timers is that should the battery have insufficient voltage or remaining capacity, the irrigation will not take place. This is unfortunate for the owner as the consequence will be the loss of plants in the garden or pots.

However a problem of more dire consequence is where after watering has commenced, and the operation of the tap timer has resulted in the battery having insufficient voltage or remaining capacity. In these circumstances, the tap timer can fail to operate to turn off the electrically operated valve. The consequence of this is that at the very least, water will be wasted.

It will be understood that if the electrically actuated/operated valve was a solenoid valve of the type where power must be maintained on to maintain the valve open, this would not be a problem, but for reasons of conserving battery power to maximise battery life in the tap timer, the valve is electrically actuated, requiring application of power to open the electrically operated valve and subsequently also requiring application of power to close the electrically operated valve. Such valves where power is required to open and again to close the valve can include rotary driven actuators that are driven in one direction to open the valve and driven in the other direction to close the valve, and latching solenoid valves which on application of current in one direction open the valve and use a magnet to latch the valve open and require delivery of current in the opposite direction to unlatch the mechanism which results in closing of the valve.

To some extent, the failure problem has been addressed by including in the tap timer a voltage set point, where if the battery voltage falls below a predetermined level, the internal circuitry is arranged to not operate the electrically operated valve to the open position, so watering will not commence. It is usually up to the owner of the tap timer to monitor the battery voltage, and replace the batteries before they reach such a discharged state that the voltage set point is reached.

However, different batteries have different characteristics, and a single voltage set point will not be suitable for different types of battery. A voltage set point that is safe for a zinc manganese dry cell would likely result in an alkaline dry cell being replaced before the end of its useful service life, and a voltage set point that is suitable for an alkaline dry cell could result in equipment failure as described above, when a zinc manganese dry cell is used.

Throughout the specification unless the context requires otherwise, the word “comprise” or variations such as “comprises” or “comprising”, will be understood to imply the inclusion of a stated integer or group of integers but not the exclusion of any other integer or group of integers.

It is an object of the invention to provide a methodology in a controller for an appliance relying on batteries for its operation, that will avoid appliance failure and maximise battery life.

### SUMMARY OF INVENTION

In accordance with the invention there is provided a controller having a power supply including a battery for supplying power and connected via a charge circuit to selectively charge a storage capacitor, said storage capacitor being connected to an actuator circuit to selectively provide power from said storage capacitor to actuate a device, wherein a processor controls said actuator circuit according to a schedule to actuate said actuator circuit to provide power from said storage capacitor to actuate said device, where when said actuator circuit is actuated said charge circuit is switched off, and when said actuator circuit is in stand-by (unactuated) said charge circuit is switched on; where said power supply includes voltage monitoring to monitor capacitor voltage; where said processor exerts over-riding control over actuation of said actuator circuit to prevent actuation of said device if the voltage of said capacitor does not reach and exceed a first predetermined level V₁ within a predetermined time T₁ after said charge circuit is again switched on after actuation of said device, said predetermined time being from 1.5 seconds to no more than 15 seconds.

The voltage monitoring may be most easily performed by the processor timing out the predetermined time from switch on of the charge circuit, where at the predetermined time, the capacitor voltage is measured via an A/D converter and compared with the stored level of V₁ to determine whether the capacitor voltage has reached or exceeded the first predetermined level.

Preferably said first predetermined level is from 50% to 70% of the rated battery voltage.

Preferably said first predetermined level is from 50% to 68% of the rated battery voltage.

Preferably said first predetermined level is from 50% to 65% of the rated battery voltage.

Preferably said first predetermined level is from 50% to 60% of the rated battery voltage.

Preferably said first predetermined level is about 55% of the rated battery voltage.

Alternatively, and more preferably said first predetermined level is from 50% to 70% of the actual battery voltage.

Alternatively, and more preferably said first predetermined level is from 50% to 68% of the actual battery voltage.

Alternatively, and more preferably said first predetermined level is from 50% to 65% of the actual battery voltage.

Alternatively, and more preferably said first predetermined level is from 50% to 60% of the actual battery voltage.

Alternatively, and more preferably said first predetermined level is about 55% of the actual battery voltage.

Preferably, said predetermined time is from 2 seconds.

Preferably, said predetermined time is from about 3 seconds.

Preferably, said predetermined time is from about 4 seconds.

Preferably, said predetermined time is from about 5 seconds.

Preferably if after said processor exerts over-riding control over actuation of said actuator circuit to prevent actuation of said device, the battery voltage fails to rise to and maintain a second predetermined level V₂ prior to said processor being scheduled to actuate said actuator circuit, said second predetermined level being greater than said first predetermined level, said processor releases said over-riding control, allowing actuation of said actuator circuit, where V₂ is greater than or equal to V₁.

Preferably said processor exerts over-riding control over actuation of said actuator circuit to prevent actuation of said device, if the battery voltage subsequently falls to fails to rise above said second predetermined level V₂.

Preferably said second predetermined level is from 55% to 75% of the rated battery voltage.

Preferably said second predetermined level is from 60% to 70% of the rated battery voltage.

Preferably said second predetermined level is from 65% to 68% of the rated battery voltage.

Preferably said second predetermined level is about 66% of the rated battery voltage.

Preferably said processor exerts over-riding control over actuation of said actuator circuit and issues a user observable notification to replace the battery, if the voltage across said capacitor falls below a third predetermined level immediately prior to said charge circuit being again switched on after actuation of said device, said third predetermined level being representative of a battery voltage V₃ less than said first predetermined level. The over-riding control in this arrangement would be expected to be continuing until a replacement battery is fitted. For ease of understanding V₃<V₁<V₂.

Preferably said third predetermined level is representative of a battery voltage from 40% to 55% of the rated battery voltage.

Preferably said third predetermined level is representative of a battery voltage from 42% to 50% of the rated battery voltage.

Preferably said third predetermined level is representative of a battery voltage from 43% to 47% of the rated battery voltage.

Preferably said third predetermined level is representative of a battery voltage of about 44% of the rated battery voltage.

The third predetermined level is a battery voltage level below which it is considered that the battery could not recover sufficiently and consequently the device would fail to actuate. The first predetermined level and the predetermined time depend on the battery voltage for the battery, the internal impedance of the charge circuit and the size of the capacitor. Typically the predetermined period would be in the order of two to three seconds for a good battery with a maximum period of five to ten seconds likely to be required as a battery ages. The second predetermined level is the minimum voltage level at which the device would be able to be actuated in the future at least two more times.

In its simplest form monitoring of the battery voltage and the capacitor voltage can be achieved by monitoring the capacitor voltage only, since the capacitor voltage lags the battery voltage due to the internal impedance of the charge circuit, but as time passes beyond the first predetermined period, the actual battery voltage and the capacitor voltage will get closer, less any forward voltage drop across the charge circuit.

Preferably said processor maintains a table of previous values for successive measured predetermined periods, and exerts over-riding control over actuation of said actuator circuit and issues a user observable notification to replace the battery, if the most recent measured predetermined period exceeds any previously stored measured predetermined period by more than 20%. Times of more than 10%, 11%, 12%, 13%, 14%, 15%, 16%, 17%, 18%, or 19% may be contemplated, but a variation of 9% would be considered to fall within the realms of a temperature induced variation.

Preferably the charge circuit is arranged to selectively supply power to the capacitor at a first rate for charging the capacitor when said charge circuit is switched on, and at a second current limited rate when said charge circuit is switched off to allow monitoring of battery current and voltage level V₃ at the highest demand stage when the capacitor is discharged, prior to again switching on said charge circuit. This allows battery voltage across a known load to be determined, to derive an indication of battery condition.

Preferably said actuator circuit is provided in the form of an H-bridge circuit, where the device is actuated to an on-condition by supplying power in one polarity and the device is actuated to an off-condition by supplying power in the opposite polarity.

Preferably said processor is arranged to not exert over-riding control over said actuator circuit to actuate said device to the off-condition after having previously actuated said device to an on-condition. In other words, preferably said processor will only exert over-riding control over actuation of said actuator circuit where the device is already actuated to an off-condition. In this way, the controller will not prevent operation to switch the device to an off-condition after having switched it on, in circumstances where it might perceive there might not be sufficient battery power. This is a fail-safe feature to avoid the device being left stranded in an on-condition.

Also in accordance with the invention there is provided a tap timer incorporating a controller as described above, where the device is a valve actuator for a valve which in a first operation is actuated to turn the valve on, and in a second operation is actuated to turn the valve off. The controller of the invention has an added advantage in this application, where in prior art tap timers the valve actuator is electric-motor driven, and at either end of the travel, the electric motor presents as a short circuit, draining the battery until the controller switches off the power to the electric motor, and shortening the battery life. In the present invention the storage capacitor is used to drive the electric motor, not the battery.

### BRIEF DESCRIPTION OF DRAWINGS

A preferred embodiment of the invention will now be described with reference to the drawings is which:

FIG. 1 is a block circuit schematic of a control circuit for a tap timer according the embodiment; and

FIG. 2 is a circuit diagram for a control circuit for a tap timer according to the embodiment.

### DESCRIPTION OF EMBODIMENTS

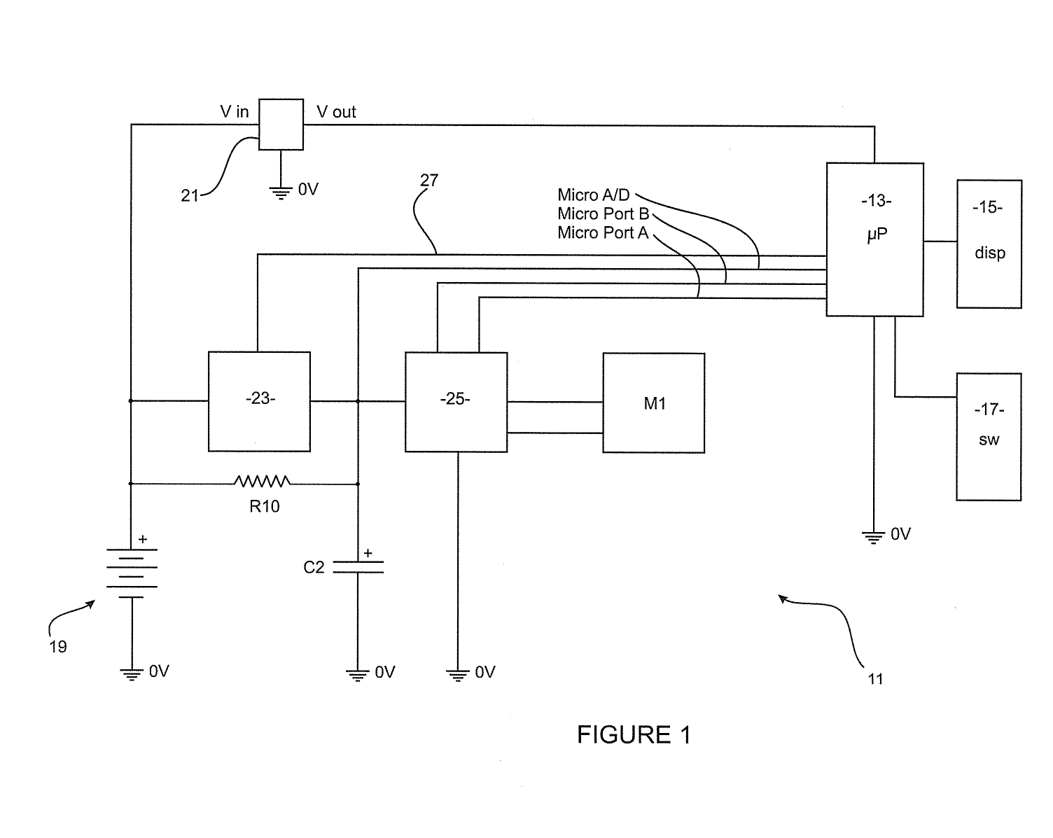

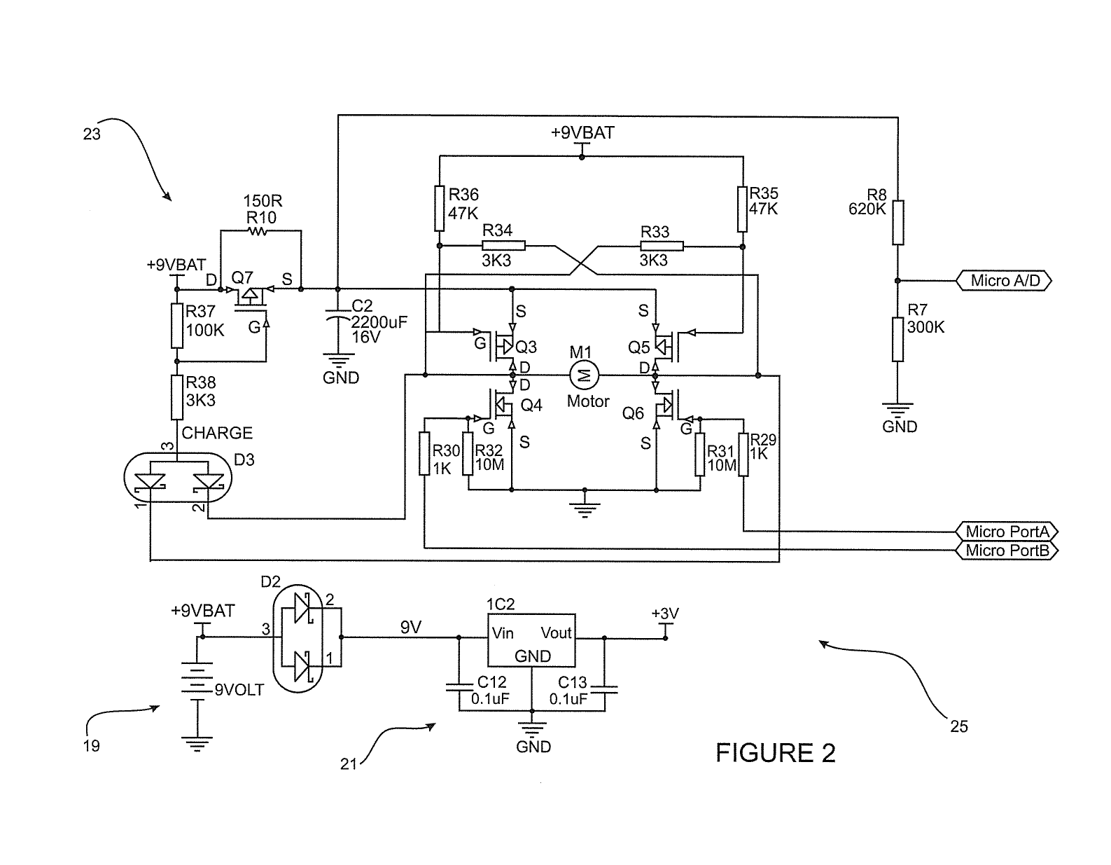

The embodiment is a controller for a tap timer and is shown in FIGS. 1 and 2.

Referring to FIG. 1 the control circuit for a tap timer 11 is shown in block diagram form. The tap timer 11 has a microprocessor 13 with a display 15 so the user can observe its status, and input switches 17 so the user can input a time schedule and also manually operate the tap timer 11.

The tap timer 11 has a 9 volt battery 19 and a voltage regulator 21 to provide the regulated 3 volt power supply required by the microprocessor 13. The power supply of the invention is formed by a charge circuit 23, a capacitor C2, a bypass resistor R10, and the battery 19.

The tap timer 11 has an electrically operated valve M1, connected with an actuator circuit 25. The actuator circuit 25 is controlled by a high from microprocessor 13 on outputs Micro PortA and Micro PortB. Voltage of the capacitor C2 is monitored by the microprocessor analog to digital input Micro A/D. Control output 27 is shown to switch charge circuit 23, but in practice this may be derived from a logic NOR of outputs Micro PortA and Micro PortB, or other means as will be apparent from FIG. 2. The required logic is that if outputs Micro PortA and Micro PortB are low, the charge circuit 23 will switch on to charge the capacitor C2, but otherwise the current path from the battery 19 to capacitor C2 is via resistor R10.

The embodiment of the invention provides a low cost method of voltage detection and then a process for monitoring of the battery energy as the battery discharged into a load. This method is provided in software as an algorithm, allowing it to be used in very simple microprocessors.

The method of monitoring the discharge rate is based on the charging and discharging of capacitor C2. The capacitor C2 is used as the storage mechanism for delivering of the energy required to open and then close the valve, and the method involves measuring of the energy used to charge this capacitor.

In the schematic shown in FIG. 2, C2 is a 2,200 uF capacitor is used as a storage capacitor to hold the charge required by M1 to either fully open or fully close the tap timer valve (i.e. to fully actuate or fully deactuate the tap timer valve).

This charge is fed to the motor or solenoid via the actuator circuit 25 formed by an “H” bridge as a short high energy pulse with a controlled pulse time width and duration. The H bridge is formed by FETs Q3, Q4, Q5 and Q6, and their associated components.

The timing of the delivery of the charge is controlled according to a time schedule that is pre-programmed into the tap timer 11 by the user, or may be through manual on/off commands entered into the tap timer 11 by the user. The tap timer 11 valve is driven by a motor M1, with the motor being run in a first direction to open the valve and in the reverse direction to close the valve.

Due to the construction of the “H” bridge it is possible to control the polarity of the charge supplied to M1 via the two microprocessor pins marked Micro PortA and Micro PortB. The motor is run in the first direction switched via FETs Q6 and Q3 when their gates are energised by application of a voltage at Micro PortA by the microprocessor, and run in the second direction switched via FETs Q4 and Q5 when their gates are energised by application of a voltage at Micro PortB by the microprocessor. A high on either of these ports will cause the current to flow in one or the other direction, and when both ports are off the “h” bridge becomes fully disconnected.

A third microprocessor pin is also used and this is attached to the microprocessor via an A/D (if one is available) or through a comparator with a charge timer delta A/D mechanism (if it is not.)

When Micro PortA and Micro PortB are at rest, that is they are both low, then TP3 on Q7 is high. This means Q7 conducts current from the 9 volt block battery to C2. This state only occurs when the “H” bridge is in the rest condition.

The A/D reading is taken of this rest position and this value becomes the no load voltage of the battery. This reading is regularly checked (once per hour) and should it drop below a second predetermined level V₂ of about two thirds of the rated battery voltage (6.2 volts for a 9 volt block alkaline battery) then the microprocessor over-rides the operation of output Micro PortA, effectively shutting down the tap timer 11 so that no start is allowed; that is to say, the switching of FETs Q6 and Q3 is over-ridden so that the motor will not be run in the first direction to actuate the tap timer. However, if the motor has already been run in the first direction, and the battery voltage is subsequently checked and found to be below 6.2 volts, the processor will not over-ride operation of Micro PortB and the FETs Q4 and Q5, allowing the motor to run in the second direction in order to fully close off the valve and thereby de-actuate the tap timer and shut off the watering. In this manner, the tap timer will not be left in a compromised condition where the valve is left open.

Should this no load voltage increase at a later time to rise above 6.2 volts, due to battery recovery or environmental conditions then the micro-processor release the over-riding control over Micro PortA, and again the tap timer 11 is allowed to open (and shut) the valve.

The rate of charge of the capacitor C2 can also be determined using the above mechanism, and this also allows the maximum droop that the battery suffers when it is charging the capacitor C2 to be measured. This is achieved by knowing the “No Load Voltage” and then by collecting the voltage when the battery is put under a known load.

The measuring of the battery voltage when the battery is out under a known load takes place when the tap timer actuator circuit 25 is actuated to open or close the valve. In this situation a series of values that represent the fully charged position of the capacitor C2 to the fully discharged position can be measured and stored in memory in the microprocessor. This occurs as the motor M1 consumes the stored power in capacitor C2. Once all the current has been used from C2 another measurement is taken which gives the voltage value through the now stalled motor and the current drop across R10. With this data, information unique to the battery that is in use is calculated.

Voltage curve data is updated on each open and close of the valve that details the droop from steady state to full loaded. If the full loaded voltage falls to a level representative of a battery voltage under load of below 4 volts (being the third predetermined level V₃ described above) the microprocessor considers the battery to be too risky to keep in use, the tap timer is shut it down, and a flat battery indicator is activated in the display 15.

At full load the voltage will drop and as the load is released and the battery begins to charge, the time taken for the battery voltage level to reach 55% of the no load voltage is measured. This time is stored in a table and should the latest time exceed the previous stored time by more than 20% or the time taken to reach 55% of the no load voltage exceed 10 seconds, the microprocessor operates to exert over-riding control over operation of the tap timer.

Should the steady state of this particular battery improve over time to reach the second predetermined level V2, then the microprocessor will release over-riding control and again allow the tap timer to open and close the valve again.

As discussed, the current curve data for the battery, is derived by collecting data as the capacitor is recharged via the FET Q7. As the exact internal resistance of the FET Q7 when on is known, and the differential voltage across the FET Q7 is known (ie comparing the steady state voltage V₂ when the capacitor is charged and the voltage as Q7 allows current to pass and charge C2), from this information the amp hours left in the battery can be approximated and it can be predicted by observing increasing predetermined time periods T₁ at what point the battery might fail. This prediction point plus a small amount to allow for error is used as the set point for the microprocessor to inhibit any further opening or closing of the valve.

With this technique, the life of the battery is now maximised and every time the tap timer is opened or closed, the trip point based on ΔT₁ is recalculated and redefined. This means the only time the tap timer stops completely is when there is no chance that the battery might recover or have any further charge above what is required to open and close the valve.

The unique properties of this mechanism is that it can fully realise and calculate the life expectancy of an attached battery regardless of the battery chemistry and it can determine a line of best fit for long term operation that is updated regularly as the battery comes under load. This type of mechanism is cheap easily realisable on the simplest microprocessor and provides the best use of limited resource batteries.

In effect the capacitor value is selected so that at a minimum voltage there will be sufficient stored charge to perform the actuation or deactuation of the valve. Various parameters as described above are monitored in order to make a determination as to whether the tap timer is fit for continued operation, especially after the most recent deactuation, or whether the battery should be replaced.

The following table sets out the semiconductor devices used in the circuit diagram of FIG. 2:

| | | |
|---|---|---|
| Q3 | IRLM6402 | P-Channel FET |
| Q4 | IRLM2030 | N-Channel FET |
| Q5 | IRLM6402 | P-Channel FET |
| Q6 | IRLM2030 | N-Channel FET |
| Q7 | IRLM6402 | P-Channel FET |
| IC2 | MCP1702 | Voltage Regulator |
| D2 | BAT54ALT | Schottky Barrier Diodes |
| D3 | BAT54ALT | Schottky Barrier Diodes |

It should be appreciated that the scope of the invention is not limited to the particular embodiment described herein. In particular the control circuit of the invention may be used in any battery powered appliance or other appliance having a power supply with limited current capacity, where current draw to actuate or to deactuate the appliance is higher than the standby current.

1. A controller having a power supply including a battery for supplying power to said controller, said controller having an actuator circuit to actuate a device, where a processor powered from said battery controls said actuator circuit according to a schedule to actuate said actuator circuit; wherein said battery is connected via a charge circuit to selectively charge a storage capacitor, said storage capacitor being connected to said actuator circuit to selectively provide power from said storage capacitor to actuate said device, wherein when said actuator circuit is actuated said charge circuit is switched off, and when said actuator circuit is in stand-by (unactuated) said charge circuit is switched on; where said power supply includes voltage monitoring to monitor capacitor voltage; where said processor exerts over-riding control over actuation of said actuator circuit to prevent actuation of said device if the voltage of said capacitor does not reach and exceed a first predetermined level V₁ of from 50% of the rated battery voltage within a predetermined time T₁ after said charge circuit is again switched on after actuation of said device, said predetermined time being from 1.5 seconds to no more than 15 seconds.

2. A controller as claimed in claim 1 wherein the voltage monitoring is performed by the processor timing out the predetermined time from switch on of the charge circuit, where at the predetermined time, the capacitor voltage is measured via an analog to digital converter and compared with the stored first predetermined level of V₁ to determine whether the capacitor voltage has reached or exceeded the first predetermined level.

3. A controller as claimed in claim 1 wherein said first predetermined level is from 50% to 70% of the rated battery voltage.

4. A controller as claimed in claim 1 wherein said first predetermined level is from 50% to 60% of the rated battery voltage.

5. A controller as claimed in claim 1 wherein said first predetermined level is from 50% to 70% of the actual battery voltage.

6. A controller as claimed in claim 1 wherein said first predetermined level is from 50% to 60% of the actual battery voltage.

7. A controller as claimed in claim 1 wherein said predetermined time is from 2 seconds.

8. A controller as claimed in claim 1 wherein said predetermined time is up to about 10 seconds.

9. A controller as claimed in claim 1, wherein if after said processor exerts over-riding control over actuation of said actuator circuit to prevent actuation of said device, the battery voltage fails to rise to and maintain a second predetermined level V2 prior to said processor being scheduled to actuate said actuator circuit, said second predetermined level being greater than said first predetermined level, said processor releases said over-riding control, allowing actuation of said actuator circuit, where V₂ is greater than or equal to V₁.

10. A controller as claimed in claim 9 wherein said processor exerts over-riding control over actuation of said actuator circuit to prevent actuation of said device, if the battery voltage subsequently falls to fails to rise above said second predetermined level V₂.

11. A controller as claimed in claim 9 wherein said second predetermined level is from 55% to 75% of the rated battery voltage.

12. A controller as claimed in claim 9 wherein said second predetermined level is from 60% to 70% of the rated battery voltage.

13. A controller as claimed in claim 9 wherein said processor exerts over-riding control over actuation of said actuator circuit and issues a user observable notification to replace the battery, if the voltage across said capacitor falls below a third predetermined level immediately prior to said charge circuit being again switched on after actuation of said device, said third predetermined level being representative of a battery voltage V3 less than said first predetermined level.

14. A controller as claimed in claim 10 wherein said third predetermined level is representative of a battery voltage from 40% to 55% of the rated battery voltage.

15. A controller as claimed in claim 10 wherein said third predetermined level is representative of a battery voltage from 42% to 50% of the rated battery voltage.

16. A controller as claimed in claim 1, wherein said processor maintains a table of previous values for successive measured predetermined periods, and exerts over-riding control over actuation of said actuator circuit and issues a user observable notification to replace the battery, if the most recent measured predetermined period exceeds any previously stored measured predetermined period by more than 20%.

17. A controller as claimed in claim 1, wherein said processor maintains a table of previous values for successive measured predetermined periods, and exerts over-riding control over actuation of said actuator circuit and issues a user observable notification to replace the battery, if the most recent measured predetermined period exceeds any previously stored measured predetermined period by more than 15%.

18. A controller as claimed in claim 1, wherein the charge circuit is arranged to selectively supply power to the capacitor at a first rate for charging the capacitor when said charge circuit is switched on, and at a second current limited rate when said charge circuit is switched off to allow monitoring of battery current and voltage level V₃ at the highest demand stage when the capacitor is discharged, prior to again switching on said charge circuit.

19. A controller as claimed in claim 1, wherein said actuator circuit is provided in the form of an H-bridge circuit, where the device is actuated to an on-condition by supplying power in one polarity and the device is actuated to an off-condition by supplying power in the opposite polarity.

20. A controller as claimed in claim 1, wherein said processor is arranged to not exert over-riding control over said actuator circuit to actuate said device to the off-condition after having previously actuated said device to an on-condition.

21. A tap timer incorporating a controller as claimed in claim 1, where the device is a valve actuator for a valve which in a first operation is actuated to turn the valve on, and in a second operation is actuated to turn the valve off.
